(19) United States
(12) Patent Application Publication
(10) Pub. No.: US 2013/0107031 A1
(43) Pub. Date: May 2, 2013

(54) Underwater Digital Video Camera Recorder for Fishing

(71) Applicant: Robert Emmett Atkinson, White Bear Lake, MN (US)

(72) Inventor: Robert Emmett Atkinson, White Bear Lake, MN (US)

(21) Appl. No.: 13/666,699

(22) Filed: Nov. 1, 2012

Related U.S. Application Data
(60) Provisional application No. 61/554,001, filed on Nov. 1, 2011.

(51) Int. Cl. H04N 7/18

(52) U.S. Cl. 348/81; 348/E07.085

(57) ABSTRACT

The present invention described various embodiments of underwater digital video camera and recorder (DVC/R) devices and associated methods for capturing and storing images and video of fish responding to artificial, live or dead bait. The DVC/R device may be in the form of a fishing lure, an in-line device, a float or other configuration. The DVC/R device may continually capture underwater video while the angler is fishing, and continuously store the video in memory (e.g., FIFO protocol) for subsequent review by the angler.

### FIELD OF THE INVENTION

The present invention generally relates to underwater cameras and methods of their use in sport fishing.

U.S Patent Publication No. 20080148621 to Vadim Laser discloses a video fishing rod with underwater observation gear as fishing equipment, allowing surveillance of the bait and fish around it, and includes a video monitor attachable to the fishing pole, miniature submersible video camera attached close to the end of the fishing line for transmitting video images up to the monitor via the same fishing line without the use of a video cable. At paragraph 0026, Laser discloses the video fishing rod system can have a standard RCA connector with the video signal available for connecting to an outside recorder.

U.S Patent Publication No. 20070242134 to Jeffrey Zernov discloses a modular, portable, submersible video viewing system. The system includes a viewing monitor, camera and interconnecting multi-conductor cable that store and deploy for underwater viewing. At paragraph 0116, Zernov discloses that the cable from the spool separately couples to a remote monitor or a video recorder (not shown).

U.S Patent Publication No. 20069216007 to Philip Moreb discloses a combination underwater camera and above-board monitor to view objects below the surface of a lake or other body of water. This combination includes a waterproof carrying ease in which a camera and a monitor would be housed. The camera is encased in a torpedo-like shell having a number of stabilizing fins attached thereto. In use, the camera would be submerged and a video cable would connect the camera to the video monitor housed within the carrying case located on a boat or vessel.

U.S Patent Publication No. 20050200699 to Mu-Joong Kim discloses a multifunctional cable, fishing equipment and underwater imago video system using the same. The multifunctional cable comprises electric cords, a image signal cord and one or more control cords to transfer signals of sounds, supersonic waves, temperature information or control orders with individual inner coats, and exterior of these cords are molded or filled with flexible and durable molding resin or fibers, and the outer surface of the cable is covered with an abrasion resistant coat. Kim also discloses fishing equipment with video system and underwater image video systems wherein the devices of the photographing part are under the water and external devices are out of the water and connected with each other using said multifunctional cable.

U.S Patent Publication No. 20050036031 to Eric Weber discloses an underwater fishing camera including a watertight housing having a transparent part and a video tube received in the watertight housing. The video tube has a light receiving input positioned to view through the transparent part of the watertight housing. A cable is coupled to the watertight housing for suspending the watertight housing in a body of water. The watertight housing and the cable are configured whereupon, when the watertight housing is suspended by the cable in a body of water moving relative to the watertight housing, the watertight housing is responsive to force(s) applied thereto by the water due to said relative movement such that the transparent part of the watertight housing faces in a downstream direction in the body of water moving relative to the watertight housing.

U.S Patent Publication No. 20010048468 to Stephen J Fantone et al. discloses a video observation system, useful for location of fish and other plant and animal life underwater, comprises a solid state imager having substantial sensitivity to infrared radiation; video signal generating means for generating a video signal corresponding to the image formed on the solid state imager; mounting means for mounting the solid state imager on a submersible portion of a watercraft; and a video display device arranged to display a visible image corresponding to the image formed on the solid state imager.

U.S. Pat. No. 6,100,921 to Steven Rowley discloses a video camera assembly which is adapted to be mounted so a thru-hull fitting so as to allow for safe and dependable viewing in various environments. A primary embodiment of the invention allows for underwater viewing by use of a conventional thru-hull fitting found on most boats. The camera includes a modified transducer body with a self-contained miniaturized camera available for coupling to a television or video monitor in a safe and protected location.

U.S. Pat. No. 6,091,443 to Randolph Ford et al. discloses a underwater viewing system suitable for providing images of an area around an underwater lure. The system includes a video camera coupled, via a cable, to a display. The cable has a plurality of electrical leads twisted about, and electrically isolated from, each other. Surrounding the electrical leads is an outer shield comprised of a plurality of stainless steel strands. The shield, and thus the cable, has an outer diameter less than 0.070 inches.

U.S. Pat. No. 4,935,906 to William Baker et al. discloses small and easily mountable sonar devices, including three sonar transducers, two being stationary and the third being directable, the transducers being operable at various ultrasonic frequencies, to produce images of underwater features, animate and inanimate, from substantial distances in any direction around a boat. Using under keyboard control and completely integrated electronic circuitry, images and echo sounding reports are generated on a graphic video display. The images include a sector-shaped image from a sector scan which covers a selected range of azimuth angles at a selected down angle.

One significant limitation common to many of these prior art devices is the use of a cable to connect the underwater camera to equipment above-water. A cable can interfere with typical fishing gear and methods, and is not suitable to many common fishing techniques.

### SUMMARY OF THE INVENTION

To address this and other problems, the present invention provides various embodiments of underwater digital video camera and recorder (DVC/R) devices and associated methods for capturing and storing images and video of fish responding to artificial, live or dead bait. The DVC/R device may be in the form of a fishing lure, an in-line device, a float or other configuration. The DVC/R device may continually capture underwater video while the angler is fishing, and continuously store the video in memory (e.g., FIFO protocol) for subsequent review by the angler. The captured and stored video files may be subsequently viewed by the angler by communication with a separate viewing device having a display such as a laptop PC, cellular phone, personal digital assistant (PDA), sonar device, etc. Communication with the viewing device may be direct using a USB connection, for example, or indirect using a wireless Bluetooth connection, for example. The DVC/R device allows an angler to review video of fish responding (or not responding) to the bait, and make adjustments in presentation as a function of the response of the fish, to improve the likelihood of a catch or selectively catch a particular species or size of fish. The DVC/R device also provides an angler with a video record of a caught fish as it strikes the bait, as it is being fought, and as it is landed.

### BRIEF DESCRIPTION OF THE DRAWINGS

FIG. 1A is a schematic flow diagram of an underwater digital video camera and recorder (DVC/R) system incorporated into fishing tackle according to an embodiment of the present invention;

FIG. 1B is a schematic illustration of one embodiment of an underwater DVC/R system incorporated into fishing tackle, where the fishing tackle is in the configuration of a fishing lure;

FIGS. 2A-2C are illustrations of the DVC/R electronics according to an embodiment of the present invention;

FIGS. 3A-3D are schematic illustrations of fishing lures containing a DVC/R;

FIGS. 4A-4D are schematic illustrations of in-line devices containing a DVC/R;

FIG. 5 is a schematic illustration of a float containing a DVC/R;

FIG. 6 is a schematic illustration of a terminal device containing a DVC/R;

FIGS. 7A-7F are schematic illustrations of various alternative configurations of the DVC/R and associated host device; and

FIGS. 8A-8E are electronic block diagrams of the DVC/R and host devices shown in FIGS. 7A-7F.

### DETAILED DESCRIPTION OF THE INVENTION

The following detailed description should be read with reference to the drawings in which similar elements in different drawings are numbered the same. The drawings, which are not necessarily to scale, depict illustrative embodiments and are not intended to limit the scope of the invention. Features described with reference to one embodiment may be incorporated into other embodiments alone or in combination.

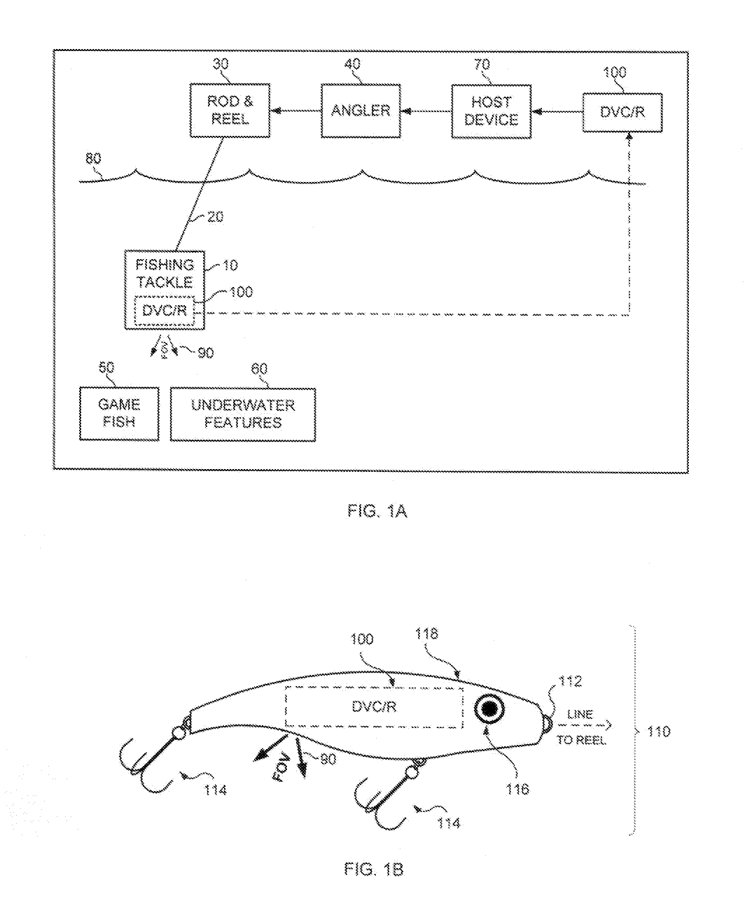

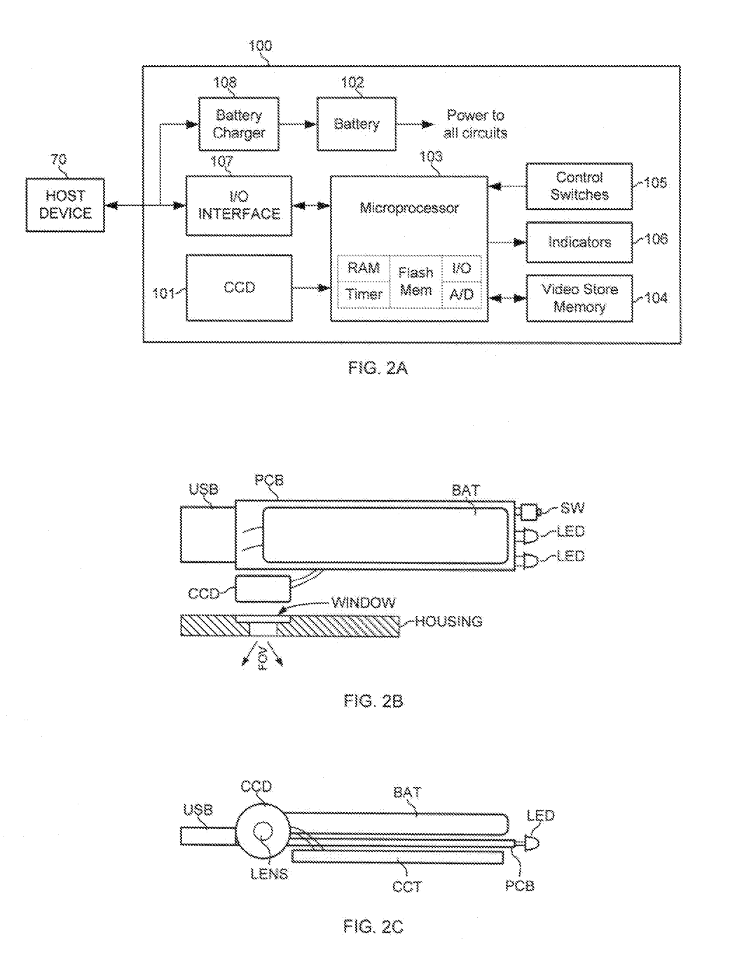

FIG. 1A is a schematic flow diagram of an underwater digital video camera and recorder (DVC/R) system 100 and associated fishing tackle 10 according to an embodiment of the present invention. In this embodiment, an angler 40 uses a conventional rod and reel arrangement 30 (above the water line 80) connected to fishing tackle 10 (below the water line 80) via standard fishing line 20. The fishing tackle 10 may comprise an artificial lure, a float, a sinker, an in-line device, a terminal device or other underwater fishing device, specific examples of which are described in more detail hereinafter. The fishing tackle 10 contains a digital video camera and recorder (DVC/R) unit 100 for capturing and storing underwater images and video.

As will be described in more detail hereinafter, the DVC/R unit 100 generally includes an image sensor such as a charge-coupled device (CCD) and associated lens, a power source such as a battery, and a circuit for controlling various functions of the system. The DVC/R unit 100 is contained in a water-resistant housing, which may form a part of the fishing tackle 10. The image sensor and lens are positioned adjacent a transparent portion of the water-resistant housing to provide a field of view (FOV) 90.

The DVC/R unit 100 captures and stores images and video of game fish 50 responding to the fishing tackle 10. Images and video of other underwater features 60 such as terrain and/or structure may be captured and stored as well. To accomplish this, the angler 40 activates a switch on the DVC/R unit 100 to begin receding images and video, then casts or otherwise submerges the fishing tackle 10 and DVC/R unit 100 underwater. After a period of time in which the DVC/R unit 100 records underwater images and video, the angler 40 retrieves the fishing tackle 10 above water, deactivates the switch on the DVC/R unit 100 to stop recording, and connects the DVC/R unit 100 to a host device 70 having a display such as a portable computer, a sonar unit, a GPS unit, a personal mobile device (e.g., cell phone) or a dedicated device.

The recorded digital image and video data are transferred from the DVC/R unit 100 to the host device 70 for viewing by the angler 40, and optionally for storing the transferred data and charging the DVC/R unit 100. In this manner, the angler 40 can view images and video of the fish 50 responding (or not responding) to the tackle 10, and make adjustments in presentation as a function thereof, thus improving the likelihood of catching the fish 50 or selectively catching a particular species or size of fish. The images and video can also provide the angler 40 with a visual record of a fish 50 as it strikes the bait, as it is being fought, and as it is landed. The images and video can further provide the angler 40 with information regarding underwater features 60 such as terrain, submerged tress, stumps, weeds, rocks, etc.

FIG. 1B schematically illustrates one embodiment of an underwater DVC/R system where the fishing tackle 10 is in the configuration of a fishing lure 110. Lure 110 includes a water-tight housing 118 for containing DVC/R unit 100. The lure 110 may include an eyelet 112 for connection to fishing line, one or more hooks 114, a pair of eyes 116, and other conventional fishing lure pans and markings. The DVC/R unit 100 residing in the housing 118 may include an image sensor such as a charge-coupled device (CCD) and associated lens. The lens of the image sensor is positioned adjacent to a transparent window in the housing 118 to provide a field of view (FOV) 90. The transparent window may include an optical filter or the like.

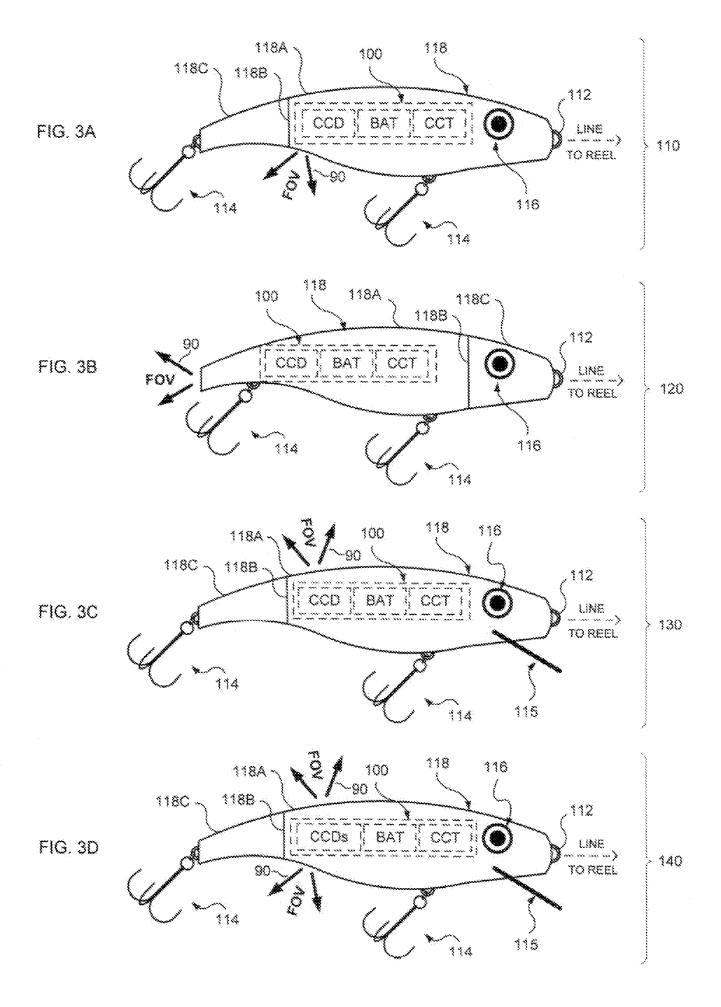

FIG. 2A is a schematic block diagram of electronics in DVC/R unit 100 according to an embodiment of the present invention. As described previously, the DVC/R unit 100 generally includes an image sensor such as a CCD 101, a power source such as a rechargeable battery 102, and a microprocessor 103 for controlling various functions of the system. The microprocessor has internal memory, timers, I/O and A/D, Digital image and video data are stored in non-volatile memory 104 such as a micro SD card, USB memory or the like. The DVC/R unit 100 also has simple switch controls 105 and indicators 106 (e.g., LEDs) to allow the user to activate/deactivate recording and playback. The DVC/R unit 100 also has an I/O interface 107 such as USB that allows the memory content to be uploaded to a host device 70 for display, storage and editing. The battery 102 can be recharged via battery charger circuit 108 when connected to host device 70.

Image and video data may be stored in non-volatile memory 104 in discrete image or video files corresponding to when recording is started and stopped. For running video, data may be separated into a series of clip files, sized 1%-10% of the total storage capacity for example, and automatically retained in memory on a first-in, first-out (FIFO) priority basis as memory becomes full. Image and video data files may remain in non-volatile memory 104 until accessed and deleted by the user.

FIGS. 2B and 2C are side and bottom views, respectively, showing the arrangement of components of the DVC/R unit 100 according to an embodiment of the present invention, which may be altered to accommodate the specific tackle configuration utilized. As shown, the battery (BAT) is disposed on one side of a printed circuit board (PCB) with the components (microprocessor, etc.) of the circuit (CCT) disposed on the other side. A connector plug (USB) is disposed at one free end of the PCB, with one or more switches (SW) and indicators (LEDs) disposed at the other end. The imaging device (CCD) may be connected to the CCT via wires and may be disposed in different positions depending on the desired direction of the FOV and the position of the transparent window in the housing.

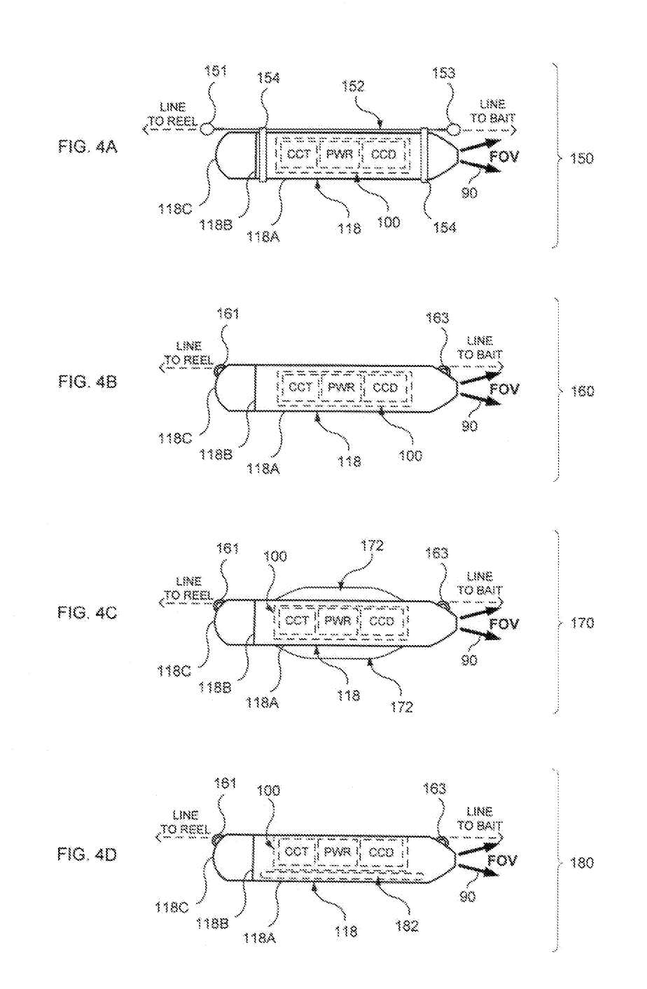

FIGS. 3A-3D schematically illustrate alternative embodiments wherein the fishing tackle 10 containing the DVC/R unit 100 is in the configuration of a fishing lure 110, 120, 130 or 140. Each of the different features of lures 110, 120, 130 and 140 may be used standing alone or in any combination. In addition, these features may be incorporated into any appropriate type of artificial lure or bait desired.

In FIG. 3A, the fishing lure 110 has a downward and slightly rearward FOV 90 which may be useful with floating, slow-sinking or suspending types of lures. This enables images of the fish to be captured as it attacks the lure 110 from below and to the rear. Lure 110 includes a water-tight housing 118 for containing DVC/R unit 100. Housing 118 is formed by a forward main body portion 118A and a rearward removable cap portion 118C. The DVC/R unit 100 resides in the main body portion 118A with the lens of the CCD positioned adjacent to a transparent window on the bottom of the main body portion 118A to allow a downward and slightly rearward FOV 90 through the housing 118. A re-closeable connection 118B is formed between the main body portion 118A and the cap portion 118C, allowing access to DVC/R unit 100 from the rear of the lure 110 when the cap 118C is removed from the body 118A, and providing a wafer-tight seal when in place. The connection 118B may comprise, for example, mating threads on the main body portion 118A and the cap 118C, with a compression ring gasket disposed in between, thus forming a mechanical connection that is water-tight. The tensile strength of the connection 118B may vary as needed for the particular species being fished (e.g., 0-50 lbs.), and the water-tight pressure rating may vary as needed for the particular depths encountered in sport fishing (e.g., 0-100 ft.). The cap 118C may exclude hook and line connections such that it is not exposed to tensile loading, thereby reducing its tensile strength requirements.

In FIG. 3B, the fishing lure 120 has a rearward FOV 90, and access to the DVC/R unit 100 is provided at the front of the lure 120. Otherwise, lure 120 may be the same as lure 110 except as differently described and shown. In this embodiment, the housing 118 includes a rearward main body portion 118A, a forward cap portion 118C, and a connection 118B in between. With this arrangement, the DVC/R unit 100 may reside in the rearward main body portion 118A adjacent a transparent window portion on the back of the main body portion 118A providing the rearward FOV 90 through the housing 118 in a direction opposite the connection 112 to the fishing line. This allows visualization of the fish as it takes the lure 120 generally from behind. The hooks 114 may be attached to the underside of the housing 118 or other location where they do not interfere with the FOV 90.

In FIG. 3C, the fishing lure 130 has a diving bill 115 and an upward FOV 90 which may be useful with diving or sinking types of lures. This enables images of the fish to be captured as it attacks the lure 130 from above. Otherwise, lure 130 may be the same as lure 110 except as differently described and shown.

In FIG. 3D, the fishing lure 140 has multiple fields of view. The DVC/R unit 100 includes two (or more) image sensors associated with corresponding transparent windows in the housing 118 of the lure 140. This enables images of the fish to be captured from different angles of attack, such as from above or behind, from the left side or the right side, etc. Images and video from each sensor may be stored in separate data files.

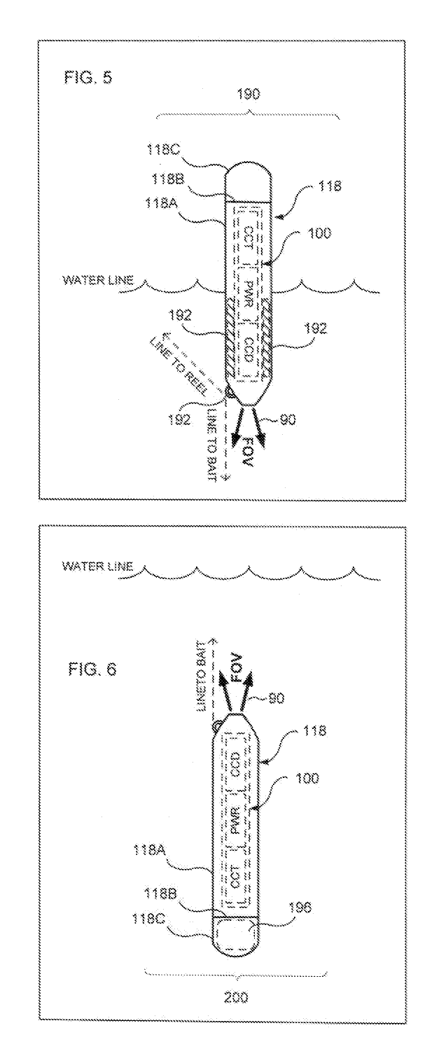

FIGS. 4A-4D schematically illustrate alternative embodiments wherein the fishing tackle 10 containing the DVC/R unit 100 is in the configuration of an in-line device 150, 160, 170 or 180. The in-line devices are configured for connection to fishing line between a fishing lure and a rod/reel combination. Each of the different features of in-lines devices 150, 160, 170 and 180 may be used standing alone or in any combination, with any appropriate type of in-line tackle desired.

In FIG. 4A, in-line device 150 includes a water-tight housing 118 for containing DVC/R unit 100. Housing 118 may be formed by a main body portion 118A and a removable cap portion 118C. A re-closeable connection 118B is formed between the main body portion 118A and the cap portion 118C, allowing access to DVC/R unit 100 when the cap 118C is removed from the body 118A, and providing a water-tight seal when in place. In-line device 150 also includes a connection member 152 in the form of a wire, for example, with a proximal eyelet 151 for connection to the fishing line extending to the rod/reel, and a distal eyelet 153 for connection to the fishing lure. Connection member 152 may be connected to the housing 118 using straps 154 or other suitable means such as adhesive, or may be connected thereto by insert molding the connection member 152 in the housing 118. Connection member 152 bears the tensile load applied by the fishing line, thus relieving the load on the connection 118B between the main body 118A and cap 118C of the housing 118. The DVC/R unit 100 is disposed in the main body portion 118A of the housing 118 with the lens of the imaging sensor positioned adjacent to a transparent window in the housing 118 to provide a rearward FOV 90 to capture images of the fishing lure. The connection means 152 may be positioned off-axis relative to the fishing line such that the FOV 90 is not obscured. With this arrangement, the FOV 90 of the in-line device 150 is kept in alignment with the fishing lure, regardless of what type (floating, diving, etc.) of fishing lure is utilized. To this end, the weight and drag of the in-line device 150 may be minimized, and the buoyancy of the in-line device may be neutral to minimize interference with the natural action of the fishing lure.

In FIG. 4B, the in-line device 160 includes eyelets 161 and 163 that are formed integrally with the housing 118. Otherwise, in-line device 160 may be the same as in-line device 150 except as differently described and shown. With eyelets 161 and 163, the connection 118B between the main body 118A and cap 118C of the housing 118 bears the tensile load applied by the fishing line, thus the connection 118B may be configured to withstand loads approximating or exceeding the tensile strength of the fishing line.

In FIG. 4C, in-line device 170 includes one or more fins 172 to aid in stabilizing the in-line device 170. Otherwise, in-line device 170 may be the same as in-line device 160 except as differently described and shown. Fins 172 may be beneficial, for example, to reduce line twist and unwanted motion of the in-line device 170 relative to the fishing lure, thus stabilizing the FOV 90 and the corresponding images of the fishing lure.

FIG. 4D, in-line device 180 includes one or more weights 182 which may reside in or on the housing 118, preferably under the eyelets 161 and 163 to aid in stabilization. Otherwise, in-line device 180 may be the same as in-line device 160 except as differently described and shown. The one or more weights 182 may comprise lead, steel or tungsten material, for example, and may be used to adjust the buoyancy of the in-line device 180. For example, to achieve neutral buoyancy, slow sinking or fast sinking characteristics, it may be necessary to add weight 182 to the in-line device 180. Adding weight 182 to the in-line device 180 may be desirable to match the buoyancy of the lure being used. In addition, adding weight 182 may be desirable to stabilize the in-line device 180 relative to the fishing lure, thus stabilizing the FOV 90 and the corresponding images of the fishing lure.

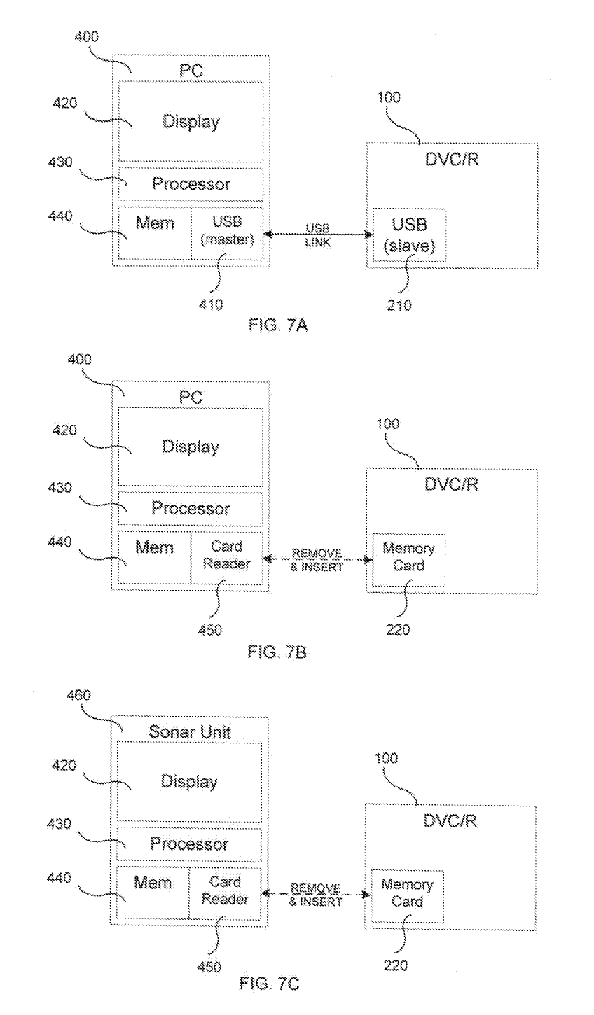

FIG. 5 schematically illustrates an alternative embodiment wherein the fishing tackle 10 containing the DVC/R unit 100 is in the configuration of a float 190. Float 190 is configured for connection to fishing line between a fishing lure and a rod/reel combination. Each of the different features of float 190 may be used standing alone or in any combination, with any appropriate type of floating tackle desired.

In FIG. 5, float 190 is connected to fishing line between the bait and the rod/reel combination via eyelet 193, which may comprise a single eyelet as shown, two separate eyelets, a clip, a spring-type connection, or other known connection means used in fishing floats. Float 190 includes a water-tight housing 118 for containing DVC/R unit 100. Housing 118 may be formed by a main body portion 118A and a removable cap portion 118C. A re-closeable connection 118B is formed between the main body portion 118A and the cap portion 118C, allowing access to DVC/R unit 100 when the cap 118C is removed from the body 118A, and providing a water-tight seal when in place. Float 190 also includes one or more weights 192 disposed at the lower end of the housing 118, which is the same end as FOV 90. Weights 192 keep the lower end of the housing 118 below the water line, while the more buoyant upper portion of the housing 118 remains above the water line as shown. However, the weights 192 do not exceed the buoyancy of the remainder float 190, such that the float 190 does not sink. A transparent window portion may be provided in the lower part of the housing 118 to provide a downward FOV 90 for visualization of the bait. With this arrangement, the FOV 90 of the float is kept in alignment with the bait below.

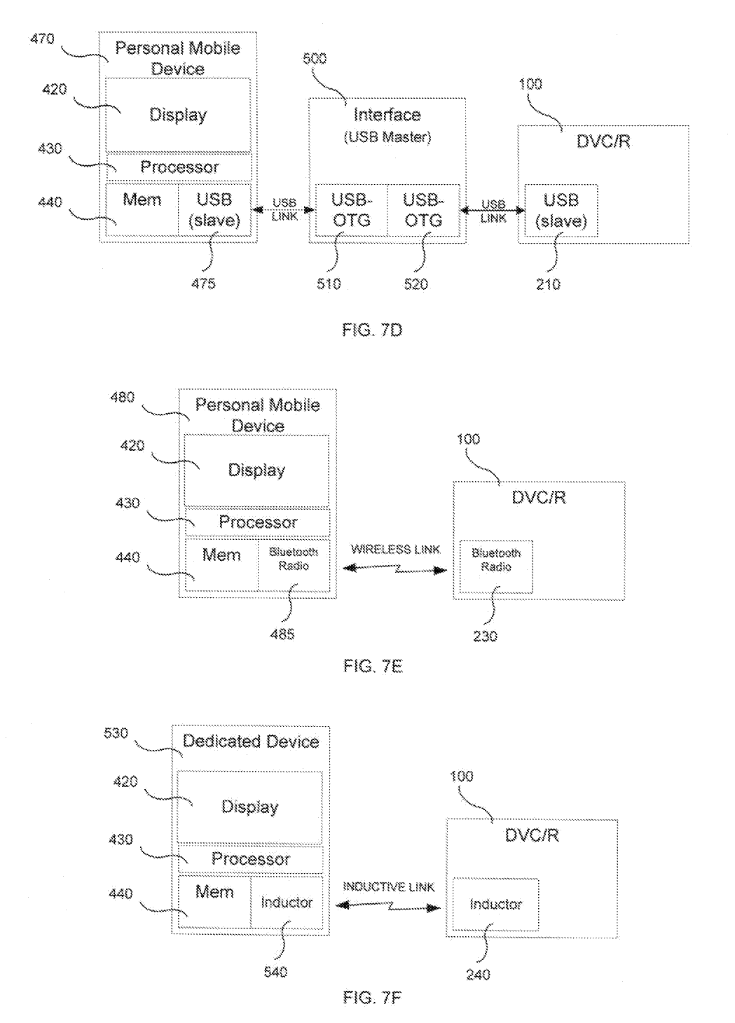

FIG. 6 schematically illustrates an alternative embodiment wherein the fishing tackle 10 containing the DVC/R unit 100 is in the configuration of a terminal device 200 such as a drop-shot. Terminal device 200 is configured for connection to fishing line distal of the lure or bait. For example, terminal device 200 may comprise a sinker (e.g., drop-shot) connected to fishing line below the lure or bait. Each of the different features of terminal device 200 may be used standing alone or in any combination, with any appropriate type of terminal tackle desired.

In FIG. 6, the terminal device 200 is connected to a terminal (distal) end of fishing line below a lure or bait via eyelet 193. Terminal device 200 includes a water-tight housing 118 for containing DVC/R unit 100. Housing 118 may be formed by a main body portion 118A and a removable cap portion 118C. A re-closeable connection 118B is formed between the main body portion 118A and the cap portion 118C, allowing access to DVC/R unit 100 when the cap 118C is removed from the body 118A, and providing a water-tight seal when in place. Terminal device 200 also includes one or more weights 196 disposed at the lower end of the housing 118, which is the opposite end as FOV 90. The one or more weights 196 keep the entire terminal device 200 below the water line, and preferably below the lure or bait. Thus, the weight 196 is selected to assure the terminal device 200 sinks well below the water line and the lure or bait. A transparent window portion may be provided in the upper part of the housing 118 to provide an upward FOV 90 for visualization of the lure or bait. With this arrangement, the FOV 90 of the terminal device 200 is kept in alignment with the lure or bait above.

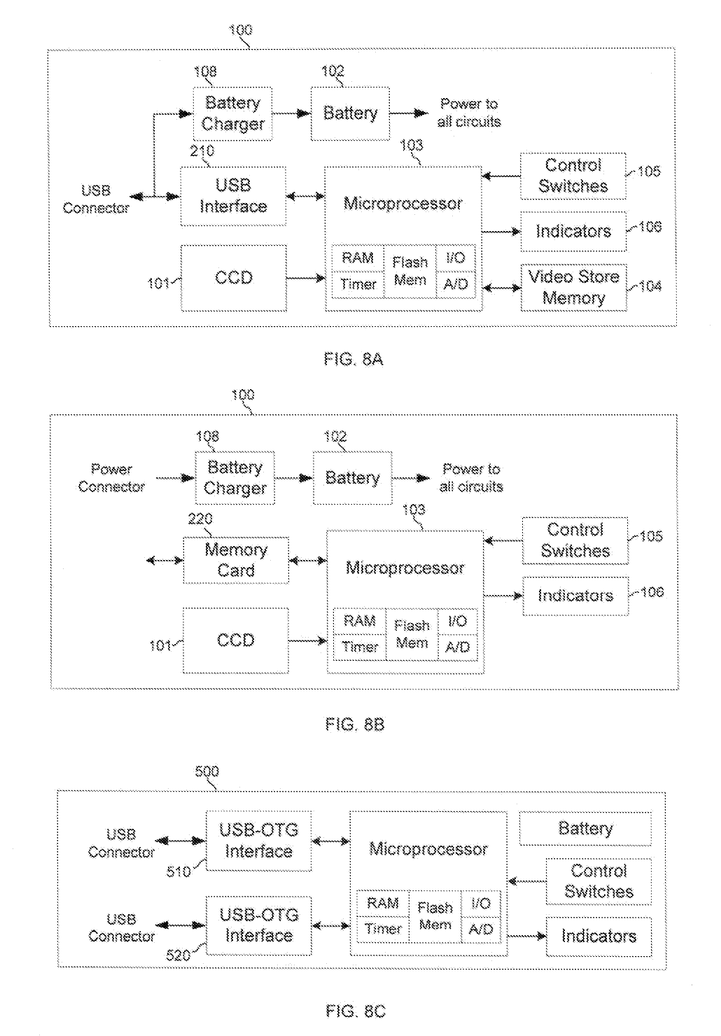

FIGS. 7A-7F illustrate various alternative configurations of the DVC/R unit 100 and the associated host devices to facilitate downloading, storing, viewing, editing, etc. the recorded images and/or video stored in DVC/R unit 100.

In FIG. 7A, the DVC/R unit 100 includes a slave USB 210 for communication with a master USB 410 in computer 400. Computer 400 may comprise a personal computer or similar device including a display 420, processor 420 and memory 440.

In FIG. 7B, image/video data is stored in DVC/R unit 100 using removable memory card 220, which can be removed therefrom and inserted into a card reader 450 associated with computer 400.

In FIG. 7C, image/video data is stored in DVC/R unit 100 using removable memory card 220, which can be removed therefrom and inserted into a card reader 450 associated with sonar unit 460. Sonar unit 460 is normally kept onboard a fishing boat, thereby facilitating downloading and viewing of image/video data from DVC/R unit 100 while the user is on the water fishing, for example.

In FIG. 7D, the DVC/R unit 100 includes a slave USB 210 for communication with a master USB interface unit 500 including USB-OTG (on-the-go) 510 and USB-OTG 520, which in turn communicates with a personal mobile device 470 (e.g., cellular phone) including slave USB 480.

In FIG. 7E, the DVC/R unit 100 includes a Bluetooth radio 230 for wireless communication with a Bluetooth radio 490 in a personal mobile device 470. This arrangement negates the need to open housing 118 to download and view image/video data from DVC/R unit 100. Although the Bluetooth radio provides for data communication between the DVC/R unit 100 and the host device 480, a wired link (e.g., USB, or plug-to-jack) may be provided to recharge the battery in the DVC/R unit 100.

In FIG. 7F, the DVC/R unit 100 includes an inductor 240 and the dedicated host device 530 includes a matched inductor 540 to provide and inductive link for data communication and battery recharging. This arrangement also negates the need to open housing 118 to download and view image/video data from DVC/R unit 100.

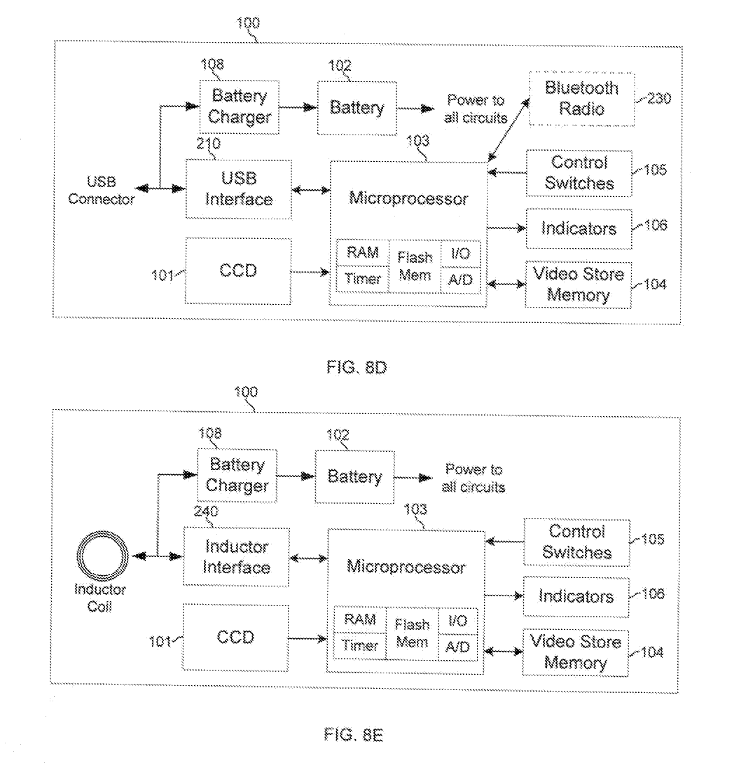

FIGS. 8A-8E schematically illustrate electronic block diagrams of the DVC/R units 100 shown in FIGS. 7A-7F. In each of the embodiments shown, the DVC/R unit 100 is a microprocessor controlled device that operates a CCD camera and stores images onto a video storage memory device. The microprocessor has internal memory, timers, I/O and A/D. The DVC/R unit 100 also has simple switch controls and indicators to allow the user to activate recording and playback. The DVC/R unit 100 includes I/O capability (e.g. USB, Bluetooth, etc.) that allows the memory content to be uploaded to a host computer or the like for display, storage and editing. The DVC/R unit 100 derives power from a battery that can be recharged when plugged into a host device. In FIG. 8A, the DVC/R unit 100 utilizes a USB link as shown in FIGS. 7A and 7D. In FIG 8B, the DVC/R unit 100 utilizes a removable memory card for data transfer and a power connection for recharging the battery as shown in FIGS. 7B and 7C. In FIG. 8C, the interface unit 500 serves as the master USB device as shown in FIG. 7D. In FIG. 8D, the DVC/R unit 100 utilizes a wireless Bluetooth link as shown in FIG. 7E. In FIG. 8E, the DVC/R unit 100 utilizes a wireless inductive link as shown In FIG. 7F.

Those skilled in the art will recognize that the present invention may be manifested in a variety of forms other than the specific embodiments described and contemplated herein. Accordingly, departures in form and detail may be made without departing from the scope and spirit of the present invention as described in the appended claims.

What is claimed is:

1. A fishing lure, comprising:
a lure body;
an eyelet connected to the lure body, the eyelet configured for connection to fishing line;
one or more fishing hooks connected to the lure body;
a digital video camera recorder (DVC/R) disposed in the hire body, the DVC/R including an image sensor and non-volatile memory for storing video data files;
a transparent window in the lure body, wherein the image sensor of the DVC/R is positioned adjacent the transparent window.

2. A fishing tackle device, comprising:
a water-tight hollow body;
an eyelet connected to the body, the eyelet configured for connection to fishing line;
a digital video camera recorder (DVC/R) disposed in the hollow body, the DVC/R including an image sensor and non-volatile memory for storing video data files; and
a transparent window in the hollow body, wherein the image sensor of the DVC/R is positioned adjacent the transparent window.

3. A sport fishing method, comprising:
connecting a fishing tackle device to fishing line, the fishing tackle device including a water-tight hollow body with a digital video camera recorder (DVC/R) disposed therein;
activating the DVC/R to initiate video recording;
capturing underwater video and storing video data using non-volatile memory in the DVC/R;
retrieving the DVC/R above water; and
accessing the video data stored in non-volatile memory.
